(19) United States
(12) Patent Application Publication
(10) Pub. No.: US 2024/0146622 A1
(43) Pub. Date: May 2, 2024

(54) SYSTEM AND METHOD FOR VISUALIZING AFFECTED NODES IN A NETWORK

(71) Applicant: Rakuten Mobile, Inc., Tokyo (JP)

(72) Inventor: Ashfaqullah KHAN, Madhya Pradesh (IN)

(21) Appl. No.: 17/755,226

(22) PCT Filed: Mar. 25, 2022
(86) PCT No.: PCT/US2022/021864

§ 371 Date: Sep. 28, 2023

(51) Int. Cl. H04L 41/22; G06F 3/0482; H04L 41/0604; H04L 41/069

(52) U.S. Cl. CPC H04L 41/22; G06F 3/0482; H04L 41/0613; H04L 41/069

(57) ABSTRACT

A method for visualizing affected network nodes includes determining a first node by an alarm event in a network; obtaining each affected node connected to the first node from a topology application programming interface (API); obtaining alarm events associated with each of the connected nodes from an alarm API; and filtering each affected node based on an event classification.

### BACKGROUND

A cellular network is a mobile telecommunication system of mobile devices (e.g., mobile phone devices) that communicate by radio waves through a local antenna at a cellular base station (e.g., a cell tower). The coverage area in which service is provided is divided into geographical areas called “cells”. Each cell is served by a separate low-power-multichannel transceiver and antenna at the cell tower. Mobile devices within a cell communicate through the cell's antenna on multiple frequencies and on separate frequency channels assigned by the base station from a common pool of frequencies used by the cellular network.

A radio access network (RAN) is part of a mobile telecommunication system and implements radio access technology. RANs reside between, and provide connection to, devices, such as a mobile phone, a computer, or any remotely controlled machine, and a core network (CN). Depending on the technical standard; mobile phones and other wireless connected devices are varyingly known as user equipment (UE), terminal equipment (TE), mobile station (MS), and the like.

### BRIEF DESCRIPTION OF THE DRAWINGS

Aspects of the present disclosure are best understood from the following detailed description read with the accompanying FIGS. In accordance with the standard practice in the industry, various features are not drawn to scale. In fact, the dimensions of the various features are arbitrarily increased or reduced for clarity of discussion.

FIG. 1 is a diagrammatic representation of an affected nodes system (ANS), in accordance with some embodiments.

FIG. 2 is a flow diagram of an affected node algorithm (ANA), in accordance with some embodiments.

FIG. 3 is a block diagram of an affected node system (ANS), in accordance with some embodiments.

FIG. 4 is a pictorial representation of an affected node graphical user interface (GUI), in accordance with some embodiments.

FIG. 5 is a pictorial representation of an affected node GUI, in accordance with some embodiments.

FIG. 6 is a pictorial representation of an affected node GUI, in accordance with some embodiments.

FIG. 7 is a high-level functional block diagram of a processor-based system, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to be in direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In a network, such as a RAN, faults (e.g., an abnormal condition or defect at the component, equipment, or sub-system level which leads to a failure or subpar performance) occurring at a single network node (hereinafter referred to as a first node) have the ability to impact other connected nodes. In some embodiments, a first node is a device that is integrated in network and monitored by a fault monitor module that is configured to send events. Currently in other approaches there is no way to monitor these connected nodes with a network tool. Further, other approaches are unable to determine how many connected nodes are affected by first connected nodes or nodes with active alarms (e.g., a mechanism that gives an audible, visual, or other alarm signal to alert someone to a problem or condition that requires attention). Further, other approaches are unable to categorize these affected nodes based on the events (such as: alarms, planned events, or the like) on these connected nodes.

In networks, such as a RAN, a node is either a redistribution point or a communication endpoint. A physical network node is an electronic device that is attached to a network, and configured for creating, receiving, or transmitting information over a communication channel (e.g., a modem, hub, bridge, switch, data terminal equipment, UE, computer, or the like). A passive distribution point such as a distribution frame or patch panel is consequently not a node. Within a network, the individual computers on the periphery of the network, those that do not also connect other networks, and those that often connect transiently to one or more clouds are called end nodes (e.g., computers, UEs, cameras, printers, or the like). Within cloud computing, the individual user or customer computer that connects into one well-managed cloud is called an end node.

In some embodiments, an affected nodes module is configured to provide visualization of connected nodes. In some embodiments, the affected nodes module provides the visualization of connected nodes in a filtered manner that categorizes faults in one or more manners correlating to events (an action or occurrence recognized by software, often originating asynchronously from the external environment, that is handled by software) on the connected nodes. In some embodiments, a user analyzes and debug the network nodes efficiently through visualization.

In a network, such as a RAN, nodes are essentially related to each other through connectivity. Thus, in response to any first node or an event that occurs on a node, connected nodes throughout the network are potentially affected. In some embodiments, connected nodes are identified from topology. In some embodiments, an affected nodes algorithm determines nodes connected to a node experiencing a fault. In some embodiments, the affected nodes algorithm further determines events occurring on the connected nodes. In some embodiments, the affected nodes algorithm significantly reduces the amount of time to debug the faults of the affected nodes. In some embodiments, the affected node algorithm significantly reduces a user's troubleshooting efforts by eliminating time consuming steps in discovering affected nodes.

Network topology is the arrangement of the elements (links, nodes, and the like) of a communication network. Network topology is used to define or describe the arrangement of various types of telecommunication networks, including command and control radio networks, industrial fieldbuses, and computer networks. Network topology is the topological structure of a network and is depicted physically or logically. Topology is an application of graph theory wherein communicating devices are modeled as nodes and the connections between the devices are modeled as links or lines between the nodes. Examples of network topologies are found in local area networks (LAN), a common computer network installation. Any given node in the LAN has one or more physical links to other devices in the network; graphically mapping these links results in a geometric shape that is used to describe the physical topology of the network. A wide variety of physical topologies have been used in LANs, including ring, bus, mesh, and star. Conversely, mapping the data flow between the components determines the logical topology of the network.

Other approaches, analyze root causes manually by looking at every occurring alarm (fault). This is extremely time consuming and inefficient. In some embodiments, the affected nodes algorithm visualizes the connected nodes for the troubleshooter through a graphical user interface (GUI). Further, the affected nodes algorithm is configured to provide the alarms and events that occur on the affected nodes.

In some embodiments, the affected nodes module reduces the efforts and time of a user by fetching connected nodes, to a node affected by a fault, from a topology application programming interface (API). In some embodiments, the affected nodes module then fetches events (active, planned, or the like) from an alarm database based on the connected nodes to the first node. In some embodiments, the affected nodes module is configured to visually present the connected nodes, which are categorized based on events broken down by event type.

In some embodiments, the affected nodes module filters out four types of events. In some embodiments, an alarm API retrieves alarms and events based upon connected nodes provide by a topology API. In some embodiments, the affected nodes module filters the nodes into (1) nodes having active alarms, (2) nodes having partially active alarms, (3) nodes having a change request (CR)/planned event, and (4) nodes without alarms.

An API is a connection between computers or between computer programs. API is a type of software interface, offering a service to other pieces of software. In contrast to a user interface (UI), which connects a computer to a person, an API connects computers or pieces of software to each other. An API is not intended to be used directly by a person (the end user) other than a computer programmer who is incorporating the API into software. An API is often made up of different parts which act as tools or services that are available to the programmer. A program or a programmer that uses one of these parts is said to call that portion of the API.

In some embodiments, in a filtered and detailed view through a GUI, a user observes and analyzes an affected node (which has any alarmed or planned event). Further, the filtered and detailed view allows the user to view the current operational situation of connected nodes with minimal effort. The user is then able to focus on the process of debugging the network nodes in contrast the time spent finding the affected node(s) in other approaches.

In some embodiments, different classifications of alarm events are filtered after being received from the alarm API, which is based on the connected nodes to the first node fetched by the topology API. In some embodiments, the topology API provides connected nodes based on the first node. In some embodiments, based on these connected nodes, an affected nodes module requests the alarm API to provide alarm events on the alarm API relating to the provided connected nodes. In some embodiments, the topology API provides other details such as node type, name, and the like. In some embodiments, the affected node module displays the affected node, connected nodes, and filtered alarm events on a GUI for a user to visualize. In some embodiments, the GUI provides a user with the ability to drill down into the displayed nodes having active alarms to discover more details by clicking or opening the node. In some embodiments, the affected nodes module allows a user to create additional filters for other types of active alarms. In some embodiments, active alarm filters include classifications and equipment identification (ID).

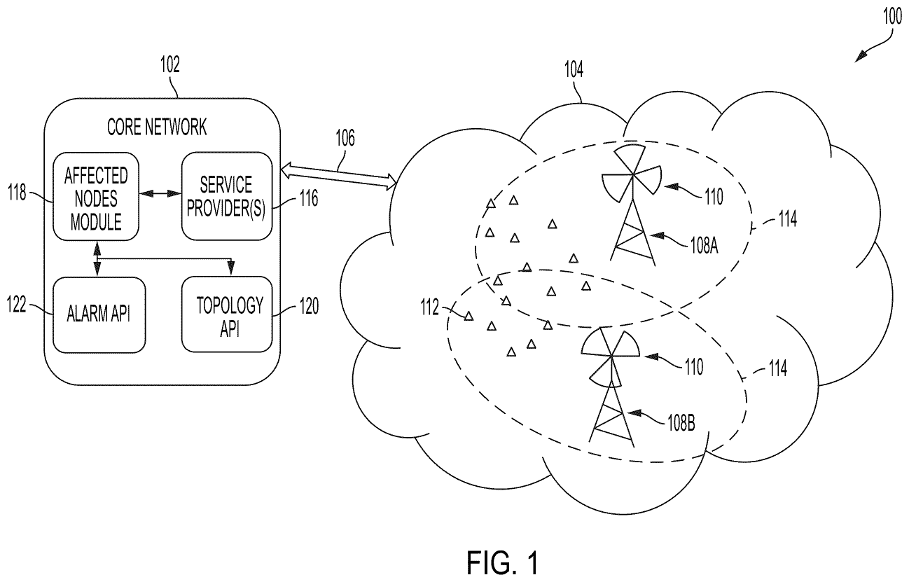

FIG. 1 is a diagrammatic representation of an affected nodes system (ANS) 100, in accordance with some embodiments.

ANS 100 includes a core network 102 communicatively connected to RAN 104 through backhaul 106, which is communicatively connected to base stations 108A and 108B (hereinafter base station 108), with antennas 110 that are wirelessly connected to UEs 112 located in geographic coverage areas 114. Core network 102 includes one or more service provider(s) 116, affected nodes module (ANM) 118, topology API 120, and alarm API 122.

Core network 102 (also known as a backbone) is a part of a computer network which interconnects networks, providing a path for the exchange of information between different local area networks (LANs) or subnetworks. In some embodiments, core network 102 ties together diverse networks in the same building, in different buildings in a campus environment, or over wide geographic areas.

In some embodiments, RAN 104 is a global system for mobile communications (GSM) RAN, a GSM/EDGE RAN, a universal mobile telecommunications system (UMTS) RAN (UTRAN), an evolved universal terrestrial radio access network (E-UTRAN, open RAN (O-RAN), or cloud-RAN (C-RAN). RAN 104 resides between user equipment 112 (e.g., mobile phone, a computer, or any remotely controlled machine) and core network 102.

In a hierarchical telecommunications network, backhaul portion 106 of ANS 100 comprises the intermediate link(s) between core network 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul generally refers to the side of the network that communicates with the global Internet. The connection between base station 108 and UE 112 begins with backhaul 106 connected to core network 102. In some embodiments, backhaul 106 includes wired, fiber optic and wireless components. Wireless sections include using microwave bands and mesh and edge network topologies that use a high-capacity wireless channel to get packets to the microwave or fiber links.

In some embodiments, base stations 108 are lattice or self-support towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers transceivers, digital signal processors, control electronics, a remote radio head (RRH), primary and backup electrical power sources, and sheltering. Base stations are known by other names such as base transceiver station, mobile phone mast, or cell tower. In some embodiments, base stations are joined with other edge devices configured to wirelessly communicate with UEs. The edge device provides an entry point into service provider core networks, such as core network 102. Examples include routers, routing switches, integrated access devices (IADs), multiplexers, and a variety of metropolitan area network (MAN) and wide area network (WAN) access devices. Further, each router, routing switch, IAD, multiplexer, and MAN and WAN access device is a node.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90° or 120° designs with a few degrees extra to ensure overlap. Further, sector antennas are mounted in multiples for wider coverage, or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties.

In some embodiments, UEs 112 are a computer or computing system. Additionally, or alternatively, UEs 112 have a liquid crystal display (LCD), light-emitting diode (LED) or organic light-emitting diode (OLED) screen interface, such as user interface (UI) 822 (FIG. 8), providing a touchscreen interface with digital buttons and keyboard or physical buttons along with a physical keyboard. In some embodiments, UE 112 connects to the Internet and interconnect with other devices. Additionally, or alternatively, UE 112 incorporates integrated cameras, the ability to place and receive voice and video telephone calls, video games, and Global Positioning System (GPS) capabilities. Additionally, or alternatively, UEs run operating systems (OS) that allow third-party apps specialized for capabilities to be installed and run. In some embodiments, UEs 112 are a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card. Each UE is an end node.

In at least one embodiment, geographic coverage areas 114 are most any shape and size. In some embodiments, geographic coverage areas 114 are a macro-cell (covering 1 Km-30 Km), a micro-cell (covering 200 m-2 Km), or a pico-cell (covering 4 m-200 m). In some embodiments, geographic coverage areas are circular, oval or sector in shape, but geographic coverage areas 114 are configured in most any shape or size. Geographic coverage areas 114 represent the geographic area antenna 110 and UEs 112 are configured to communicate.

Service provider(s) 116 are businesses or organizations that sell bandwidth or network access. Service provider(s) 116 provide direct Internet backbone access to internet service providers and usually access to network access points (NAPs). Service providers are sometimes referred to as backbone providers or internet providers. Service providers consist of telecommunications companies, data carriers, wireless communications providers, Internet service providers, and cable television operators offering high-speed Internet access.

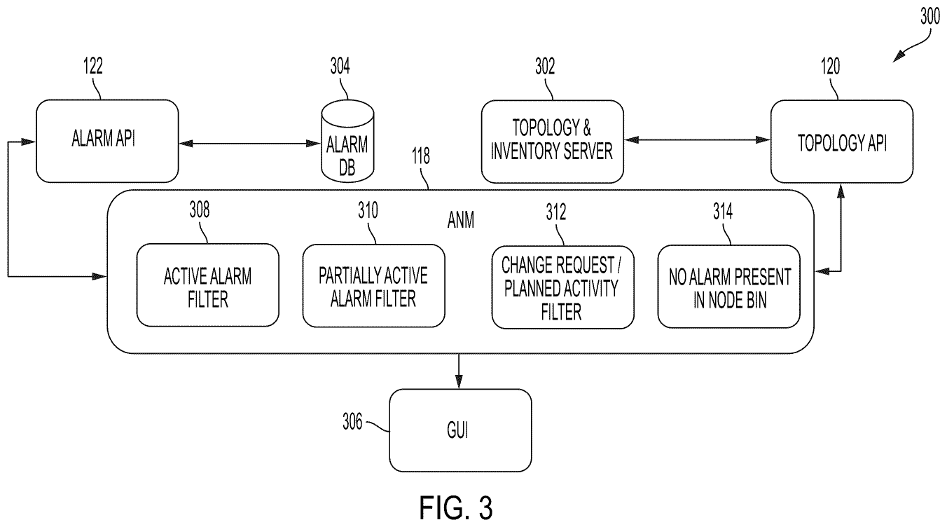

Topology API 120 is a connection between ANM 118 and a topology server 302 (FIG. 3). Topology server 302 maps the structure of a network, such as RAN 104, and depicts the network with programming logic. The topology server models nodes of a network. Topology API 120 is a type of software interface, offering a service to ANM 118. Topology API 120 is configured to provide connected nodes to ANM 118 based upon an affected node suffering an alarm event. In some embodiments, the to-be-analyzed affected node is selected by a user, such as an engineer or network operator. In some embodiments, the to-be-analyzed affected node is selected automatically upon detection of an alarm event.

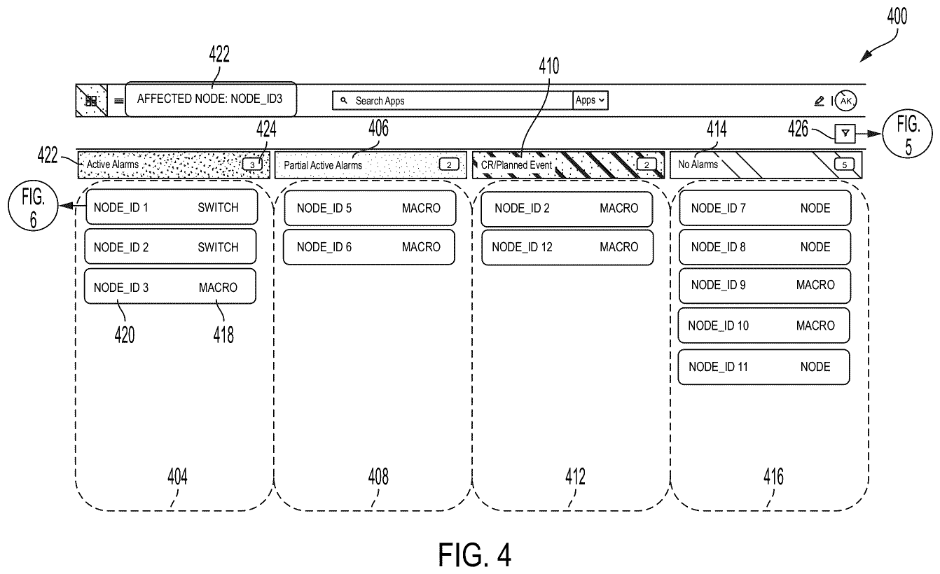

Alarm API 122 is a connection between ANM 118 and an alarm database 304 (FIG. 3). Alarm database 304 stores alarm events reported from nodes in the network, such as RAN 104. In some embodiments, alarm API 122 is collecting alarm events from alarm databased 304 based on requests from ANM 118 for alarm events relating to connected nodes reported from topology API 120. In some embodiments, alarm API 122 is filtering alarm database 304 for active alarms, partially active alarms, change requests, and planned events related to connected nodes of the first node. In some embodiments, the alarm events requested by the ANM 118 from alarm API 122 are based upon the connected nodes, provided by topology API 120 based on a connected nodes request from ANM 118. For example, in response to the discovery of an affected node (an occurrence of an alarm event), ANM 118 requests nodes connected to the first node from topology API 120. Continuing with the example, ANM 118 then requests all the alarm events from alarm API 122 for each connected node provided to the ANM 118 from topology server 120. In some embodiments, alarm API 122 provides additional details regarding the connected nodes such as node type, node name and the like and displays this information on a GUI, such as GUI 400 (FIG. 4).

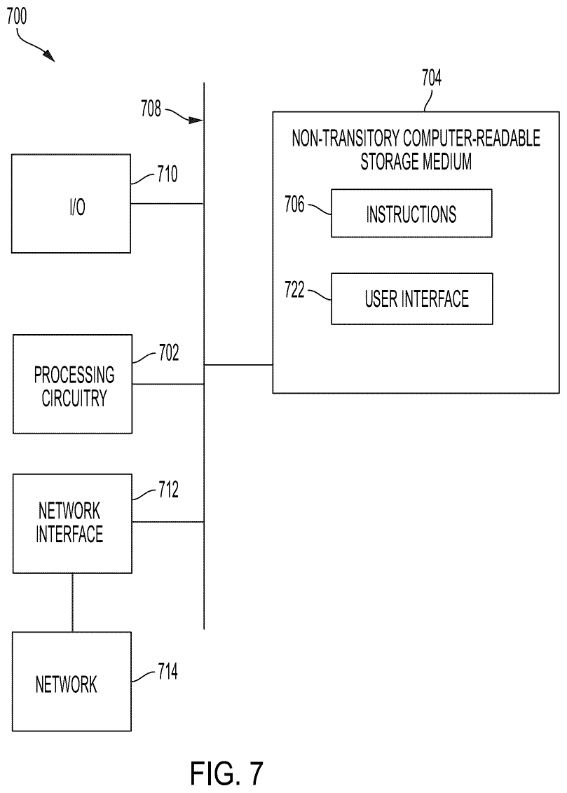

In some embodiments, ANM 118 is stored on a computer-readable medium, such as memory 704 (FIG. 7), and includes instructions, such as instructions 706 (FIG. 7), executable by processing circuitry, such as processing circuitry 702 (FIG. 7), to cause the processing circuitry to perform operations. In some embodiments, ANM 118 determines whether a node in a network, such as RAN 104, is affected by an alarm event. In some embodiments, the alarm event on the affected node is determined manually or automatically by an enterprise business management software monitoring nodes within the network. In some embodiments, ANM 118 obtains each affected node connected to the first node from a topology API 120. In some embodiments, ANM 118 obtains alarm events associated with each of the connected nodes from alarm API 122. In some embodiments, ANM 118 filters each affected node collected from topology API 120 based on an alarm event classification.

In some embodiments, ANM 118 filters each affected node for an active alarm, a partially active alarm, a change request (CR), and/or a planned event. In some embodiments, ANM classifies all remaining nodes collected as being without alarms. An active alarm is a continuous alarm. A partially active alarm is an alarm that is reoccurring, but intermittently. Change requests typically originate from one or more sources, such as (1) problem reports that identify faults, (2) system enhancement requests from users, (3) events in the development of other systems, (4) changes in underlying structure and or standards (e.g., in software development this is a new operating system). Planned events are commonly maintenance events, lifecycle events (indicating a device is at the end of a lifecycle), or software/firmware/hardware update events.

In some embodiments, ANM 118 determines a node type for each of the connected nodes. In some embodiments, the instructions further cause the processing circuitry to perform operations including determining a node name for each of the connected nodes.

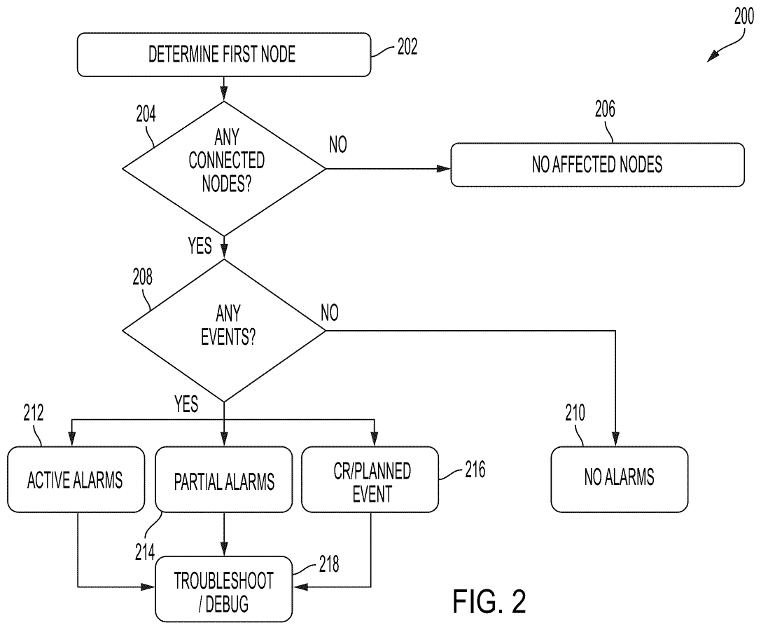

FIG. 2 is a flow diagram of affected node algorithm (ANA) 200, in accordance with some embodiments.

In some embodiments, ANA 200 is configured to provide a method for visualizing affected network nodes. While ANA 200 is presented in operations 202 through 218, unless specified these operations need not be performed in the order discussed or presented in FIG. 2.

In operation 202 of ANA 200, a first node affected by an alarm event in a network, such as RAN 104, is determined. In some embodiments, ANM 118 is automatically alerted by an alarm database, such as alarm database 304, as to an alarm event on a network. In some embodiments, a user, such as an engineer, spots or identifies an alert. In some embodiments, ANM 118 actively filters events for alarm events. From operation 202, process flows to operation 204.

In operation 204 of ANA 200, ANM 118 queries topology API 120 to obtain each affected node connected to the first node identified in operation 202. In some embodiments, topology API 120, based upon the identity of the affected node, maps connected nodes of the affected node and sends each connected node to AFM 118. Responsive to there being no connected node to the affected nodes, such as the affected node being an end node, (“NO” branch of operation 204) process flows to operation 206 where only the affected node is presented in a GUI, such as GUI 400 (FIG. 4), where the node is presented under the respective alarm heading associated with the affected node.

Responsive to the affected node having connected nodes (“YES” branch of operation 204), process flows to operation 208 where ANM 118 queries alarm API 122 for each alarm associated with each connected node identified in operation 204. Responsive to no alarms being identified with the connected nodes (“NO” branch of operation 208), process flows to operation 210 where the user is presented with a GUI, like GUI 400 (FIG. 4), displaying the first node from operation 202 is presented with the applicable alarm first detected in operation 202.

Responsive to alarms being identified and sent to ANM 118 by alarm API 122 (“YES” branch of operation 208), ANM 118 filters the alarms by type. Active alarms are filtered in operation 212, partially active alarms are filtered in operation 214, and CR or planned events are filtered in operation 216.

In FIG. 4, through operation 212, the filtered connected nodes with active alarms are presented in GUI 400 under Active Alarms heading 402 in column 404. In operation 214, the filtered connected nodes with partially active alarms are presented in GUI 400 under Partial Active Alarms heading 406 in column 408. In operation 216, the filtered connected nodes with CR and/or planned event alarms are presented in GUI 400 under CR/Planned alarms heading 410 in column 412. Returning to operation 210, the connected nodes with no alarms are presented in GUI 400 under No Alarms heading 414 in column 416. Flow proceeds from operations 212, 214, or 216 to operation 218.

In operation 218 of ANA 200, ANM 118 is configured to troubleshoot (debug) each of the alarm events filtered in operations 212, 214, and/or 216. In some embodiments, ANM 118 suggests active alarms determined in operation 212 have priority in being troubleshot or debugged as these alarms potentially cause the largest potential to affect the network. In some embodiments, a user has the ability to select which of the alarm events from operations 212, 214, and 216 the user desires to troubleshoot first. For example, an engineer discovers an alarm event with lower priority is affecting other nodes and creating alarm events with a higher priority. In some embodiments, ANM 118 is configured to troubleshoot and debug automatically based upon an artificial intelligence (AI) engine or machine learning engine that has recorded prior faults and the solution to these faults. In some embodiments, a separate AI engine troubleshoots or debugs each grouping of alarm events. For example, a separate AI engine exists for each active alarm, each partial alarm, each CR event, and each planned event. Automatic troubleshooting greatly increases the resolution of alarm events, improves the operation of the network, and decreases network latency due to alarm events.

FIG. 3 is a block diagram of an affected node system (ANS) 300, in accordance with some embodiments.

In some embodiments, ANS 300 is like ANS 100. In some embodiments, ANS 300 elements with like reference numerals indicate similar elements to ANS 100 and any description of these elements are omitted for sake of brevity and conciseness.

In some embodiments, ANS 300 provides visualization, through GUI 306, of affected network nodes. Responsive to ANM 118 determining a node in the network is affected by an alarm event, ANM 118 obtains each affected node connected to the first node from topology API 120, which is in communication with topology and inventory server 302. ANM 118 obtains alarm events associated with each of the connected nodes from alarm API 122 in communication with alarm database 304. ANM 118 filters each affected node based on an event classification. Active alarm filter 308 filters alarm events for active alarms, partially active alarm filter 310 filters alarm events for partially active alarms, change request/planned activity filter 312 filter alarm events for change requests or planned activities, and the remainder of the connected nodes are classified as without an alarm event present in the node (bin 314).

In some embodiments, alarm API 122 further provides ANM 118 with a node type for each of the connected nodes. In some embodiments, alarm API 122 further provides ANM 118 with a node name for each of the connected nodes. In FIG. 4, node type 418 and node name 420 are provided for each of the connected nodes as well as the first node.

In some embodiments, GUI 306 outputs a display on a user interface (UI), such as UI 722. In some embodiments, GUI 306 includes a first column, such as column 404 (FIG. 4), configured to display each affected node experiencing an active alarm event; a second column, such as column 408 (FIG. 4), configured to display each affected node experiencing a partial active alarm event; a third column, such as column 412 (FIG. 4), configured to display each affected node experiencing a CR or planned event; and a fourth column, such as column 416 (FIG. 4), configured to display each connected node not displayed in the first, second, and third column.

In some embodiments, GUI 306 outputs a display including a node name, such as node name 420 (FIG. 4), for each affected node, where the node name is grouped and displayed with a heading, such as headings 402, 406, 410, or 414 (FIG. 4), as to the alarm event affecting each affected node.

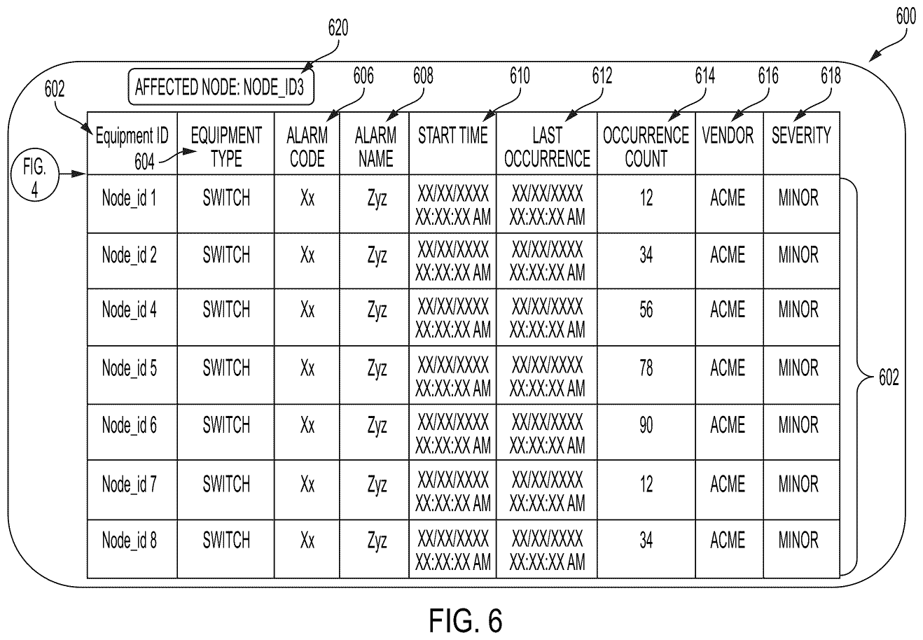

In some embodiments, the node name, such as node name 420, is a hyperlink embedded within the node name, such that, responsive to a user interface action on the node name, causes another GUI to be output by the display. In some embodiments, the additional GUI includes a listing, such as listing 600 (FIG. 6) of each alarm event for the selected node name.

FIG. 4 is a pictorial representation of an affected node graphical user interface (GUI) 400, in accordance with some embodiments.

In some embodiments, GUI 400 is like GUI 306. Reference numerals of FIG. 4 already discussed are left out for purposes of brevity and conciseness.

GUI 400 presents a user with a node name 422 for a detected or determined node affected by a fault (alarm). As discussed above, GUI 400 presents each of the nodes connected to the first node within columns 404, 408, 412, or 416 based upon an alarm associated with the connected node or the lack of alarm present for a connected node.

In addition, the originally first node, e.g., NODE_ID 3, is also listed in one of columns 404, 408, 412, or 416 based upon an alarm associated with the affected node, as shown with node name 420 and node type 418.

Columns 404, 408, 412, and 416 further include a numerical identifier 424 that displays a number correlating to several nodes with each of the alarms. Thus, a user visually identifies how many nodes have a particular fault. In some embodiments, in a response to a user prioritizing troubleshooting, the user navigates to column 404 first to resolve the active alarms. Then the user moves toward troubleshooting less troublesome faults such as the partially active alarms, CR events, and planned events.

As discussed above, a user clicks on a node name, e.g., NODE_ID 1 displayed at the top of active alarms column 404, which is hyperlinked and displays another GUI, such as GUI 600 (FIG. 6) where the user is able to visualize each of the alarms associated with the node.

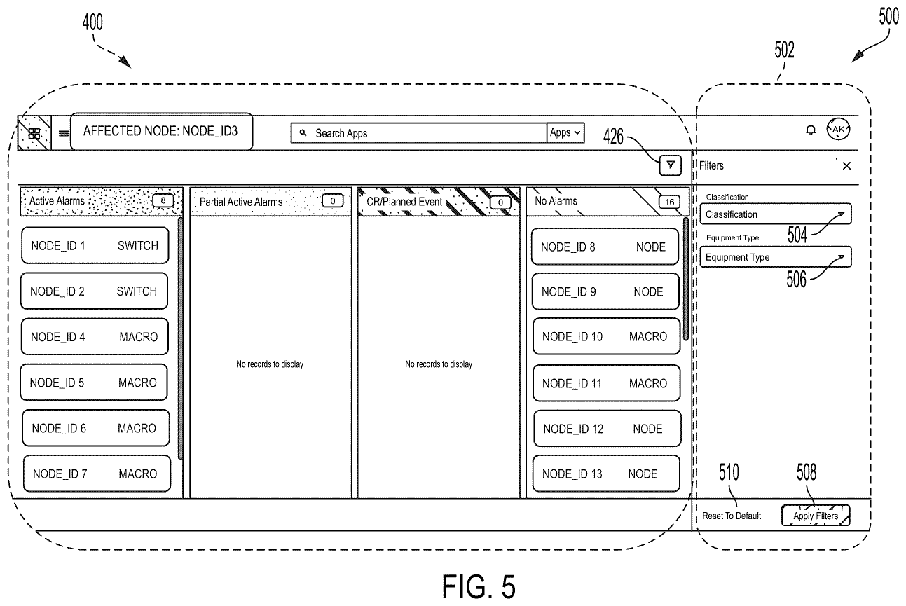

A filtering icon 426 is configured to present the user another GUI 500 (FIG. 5) with additional filtering options.

FIG. 5 is a pictorial representation of an affected node GUI 500, in accordance with some embodiments.

In some embodiments, GUI 500 is like GUIs 400 and 306. In some embodiments, in response to a user clicking on or otherwise initiates filtering icon 426, GUI 400 is reduced in width to fit GUI 500 to accommodate filter's column 502.

Filter's column 502 is configured to allow a user to select a further classification for the connected nodes to be filtered. Further, a user filters the connected nodes by the equipment type. In some embodiments, a user clicks on or otherwise initiate down-arrow 504 which will present a drop-down selection of other classifications the user is able to select to assist in trouble shooting or separating the connected nodes based on the user's preferences.

In some embodiments, a user clicks on or otherwise initiate down-arrow 506 to present a drop-down selection where the connected nodes are present or grouped by the type of equipment. This filtering is helpful as some network equipment is more vital than others and thus repair or troubleshooting to these nodes is more important than others.

A user is then able to select the apply filters button 508 to apply the configured filters. The user is also able to select reset to default button 510 to return a default GUI, such as GUI 306 or 400.

FIG. 6 is a pictorial representation of an affected node GUI 600, in accordance with some embodiments.

In some embodiments, GUI 600 is like GUIs 500, 400, and 306. In FIG. 4, a user is able to click on a node name, e.g., NODE_ID 1 which is hyperlinked and displays GUI 600 where the user is able to visualize each of the alarms 602 associated with the node.

GUI 600 is configured to provide a user with information regarding node 620 for troubleshooting. For example, a user is able to view the equipment identification (ID) 604, an equipment type 606, an alarm code 608, an alarm name 610, the first time the alarm appears at start time 612, the last occurrence time of the alarm 614, how many times the alarm has occurred at occurrence count 616, a vendor name 618, and the severity of the alarm at EMS severity 620.

In some embodiments, each listed alarm 602 is hyperlinked to another GUI where a user is able to begin active troubleshooting of the node.

FIG. 7 is a block diagram of an affected node processing circuitry 700 in accordance with some embodiments. In some embodiments, affected node processing circuitry 700 is a general-purpose computing device including a hardware processing circuitry 702 and a non-transitory, computer-readable storage medium 704. Storage medium 704, amongst other things, is encoded with, i.e., stores, computer program code, i.e., a set of executable instructions 706 such as affected node algorithm ANA 200. Execution of instructions 706 by hardware processing circuitry 702 represents (at least in part) a affected node tool which implements a portion or of the methods described herein in accordance with one or more embodiments (hereinafter, the noted processes and/or methods).

Processing circuitry 702 is electrically coupled to a computer-readable storage medium 704 via a bus 708. Processing circuitry 702 is also electrically coupled to an I/O interface 710 by bus 708. A network interface 712 is also electrically connected to processing circuitry 702 via bus 708. Network interface 712 is connected to a network 714, so that processing circuitry 702 and computer-readable storage medium 704 are capable of connecting to external elements via network 714. Processing circuitry 702 is configured to execute computer program instructions 706 encoded in computer-readable storage medium 704 to cause affected node processing circuitry 700 to be usable for performing a portion or of the noted processes and/or methods. In one or more embodiments, processing circuitry 702 is a central processing unit (CPU), a multi-processor, a distributed processing system, an application specific integrated circuit (ASIC), and/or a suitable processing unit.

In one or more embodiments, computer-readable storage medium 704 is an electronic, magnetic, optical, electromagnetic, infrared, and/or a semiconductor system (or apparatus or device). For example, computer-readable storage medium 704 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 704 includes a compact disk-read only memory (CD-ROM), a compact disk-read/write (CD-R/W), and/or a digital video disc (DVD).

In one or more embodiments, storage medium 704 stores computer program code 706 configured to cause affected node processing circuitry 700 to be usable for performing a portion or of the noted processes and/or methods. In one or more embodiments, storage medium 704 also stores information, such as affected node algorithm which facilitates performing a portion or of the noted processes and/or methods.

Affected node processing circuitry 700 includes I/O interface 710. I/O interface 710 is coupled to external circuitry. In one or more embodiments, I/O interface 710 includes a keyboard, keypad, mouse, trackball, trackpad, touchscreen, and/or cursor direction keys for communicating information and commands to processing circuitry 702.

Affected node processing circuitry 700 is also include network interface 712 coupled to processing circuitry 702. Network interface 712 allows affected node processing circuitry 700 to communicate with network 714, to which one or more other computer systems are connected. Network interface 712 includes wireless network interfaces such as BLUETOOTH, WIFI, WIMAX, GPRS, or WCDMA; or wired network interfaces such as ETHERNET, USB, or IEEE-864. In one or more embodiments, a portion or noted processes and/or methods, is implemented in two or more affected node processing circuitry 700.

Affected node processing circuitry 700 is configured to receive information through I/O interface 710. The information received through I/O interface 710 includes one or more of instructions, data, design rules, libraries of standard cells, and/or other parameters for processing by processing circuitry 702. The information is transferred to processing circuitry 702 via bus 708. Affected node processing circuitry 700 is configured to receive information related to a UI through I/O interface 710. The information is stored in computer-readable medium 704 as user interface (UI) 722.

In some embodiments, a method for visualizing affected network nodes includes determining a first node affected by an alarm event in a network; obtaining each affected node connected to the first node from a topology application programming interface (API); obtaining alarm events associated with each of the connected nodes from an alarm API; and filtering each affected node based on an event classification.

In some embodiments, the filtering based on events associated with each affected node further includes filtering each affected node for an active alarm; filtering each affected node for a partially active alarm; filtering each affected node for a change request (CR); or filtering each affected node for a planned event; and classifying remaining nodes as being without alarms.

In some embodiments, the obtaining each affected node connected to the first node from the topology API further includes determining a node type for each of the connected nodes.

In some embodiments, the obtaining each affected node connected to the first node from the alarm API further includes determining a node name for each of the connected nodes.

In some embodiments, the method further includes causing a graphical user interface (GUI) to be output by a display, the GUI including a first column configured to display each affected node experiencing an active alarm event; a second column configured to display each affected node experiencing a partial active alarm event; a third column configured to display each affected node experiencing a CR or planned event; and a fourth column configured to display each affected node not displayed in the first, second, and third column.

In some embodiments, the method further includes causing a GUI to be output by a display, the GUI including a node name for each affected node, where the node name is grouped and displayed with a heading as to the alarm event affecting each affected node.

In some embodiments, the GUI is a first GUI further including a hyperlink embedded within each affected node name, that includes, responsive to a user interface action on a selected node name, causing a second GUI to be output by the display, the second GUI including a listing of each alarm event for the selected node name.

In some embodiments, the method further including monitoring each affected node for an alarm event.

In some embodiments, a system, includes a memory having non-transitory instructions stored; and processing circuitry coupled to the memory, and being configured to execute the non-transitory instructions, thereby causing the processing circuitry to: determine a first node affected by an alarm event in a network; obtain each affected node connected to the first node from a topology application programming interface (API); obtain alarm events associated with each of the connected nodes from an alarm API; and filter each affected node based on an event classification.

In some embodiments, the non-transitory instructions further cause the processing circuitry to filter each affected node for an active alarm; filter each affected node for a partially active alarm; filter each affected node for a change request (CR); or filter each affected node for a planned event; and classify remaining nodes as being without alarms.

In some embodiments, the non-transitory instructions further cause the processing circuitry to determine a node type for each of the connected nodes.

In some embodiments, the non-transitory instructions further cause the processing circuitry to determine a node name for each of the connected nodes.

In some embodiments, the non-transitory instructions further cause the processing circuitry to cause a graphical user interface (GUI) to be output by a display, the GUI including a first column configured to display each affected node experiencing an active alarm event; a second column configured to display each affected node experiencing a partial active alarm event; a third column configured to display each affected node experiencing a CR or planned event; and a fourth column configured to display each affected node not displayed in the first, second, and third column.

In some embodiments, the non-transitory instructions further cause the processing circuitry to cause a GUI to be output by a display, the GUI including a node name for each affected node, where the node name is grouped and displayed with a heading as to the alarm event affecting each affected node.

In some embodiments, the GUI is a first GUI, the first GUI further includes a hyperlink embedded within each affected node name, where, responsive to a user interface action on a selected node name, the non-transitory instructions further cause the processing circuitry to cause a second GUI to be output by the display, the second GUI including a listing of each alarm event for the selected node name.

In some embodiments, the non-transitory instructions further cause the processing circuitry to monitor each affected node for an alarm event.

In some embodiments, a computer-readable medium including instructions executable by processing circuitry to cause the processing circuitry to perform operations including determining a first node affected by an alarm event in a network; obtaining each affected node connected to the first node from a topology application programming interface (API); obtaining alarm events associated with each of the connected nodes from an alarm API; and filtering each affected node based on an event classification.

In some embodiments, the instructions further cause the processing circuitry to perform operations including filtering each affected node for an active alarm; filtering each affected node for a partially active alarm; filtering each affected node for a change request (CR); or filtering each affected node for a planned event; and classifying remaining nodes as being without alarms.

In some embodiments, the instructions further cause the processing circuitry to perform operations including determining a node type for each of the connected nodes.

In some embodiments, the instructions further cause the processing circuitry to perform operations including determining a node name for each of the connected nodes.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they make various changes, substitutions, and alterations herein without departing from the spirit and scope of the present disclosure.

What is claimed is:

1. A method for visualizing affected network nodes, the method comprising:
determining a first node affected by an alarm event in a network;
obtaining each affected node connected to the first node from a topology application programming interface (API);
obtaining alarm events associated with each of the connected nodes from an alarm API; and
filtering each affected node based on an event classification.

2. The method of claim 1, wherein the filtering based on events associated with each affected node further comprises:
filtering each affected node for an active alarm;
filtering each affected node for a partially active alarm;
filtering each affected node for a change request (CR); or
filtering each affected node for a planned event; and
classifying remaining affected nodes as being without alarms.

3. The method of claim 1, wherein the obtaining each affected node connected to the first node from the alarm API further comprises:
determining a node type for each of the connected nodes.

4. The method of claim 1, wherein the obtaining each affected node connected to the first node from the alarm API further comprises:
determining a node name for each of the connected nodes.

5. The method of claim 1, further comprising:
causing a graphical user interface (GUI) to be output by a display, the GUI comprising:
a first column configured to display each affected node experiencing an active alarm event;
a second column configured to display each affected node experiencing a partial active alarm event;
a third column configured to display each affected node experiencing a CR or planned event; and
a fourth column configured to display each affected node not displayed in the first, second, and third column.

6. The method of claim 1, further comprising:
causing a GUI to be output by a display, the GUI comprising:
a node name for each affected node, where the affected node name is grouped and displayed with a heading as to the alarm event affecting each affected node.

7. The method of claim 6, wherein the GUI is a first GUI, the first GUI further comprises:
a hyperlink embedded within each node name, wherein:
responsive to a user interface action on a selected node name, causing a second GUI to be output by the display, the second GUI comprising:
a listing of each alarm event for the selected node name.

8. The method of claim 1, further comprising:
monitoring each affected node for an alarm event.

9. A system, comprising:
a memory having non-transitory instructions stored; and
processing circuitry coupled to the memory, and being configured to execute the non-transitory instructions, thereby causing the processing circuitry to:
determine a first node affected by an alarm event in a network;
obtain each affected node connected to the first node from a topology application programming interface (API);
obtain alarm events associated with each of the connected nodes from an alarm API; and
filter each affected node based on an event classification.

10. The system of claim 9, wherein the non-transitory instructions further cause the processing circuitry to:
filter each affected node for an active alarm;
filter each affected node for a partially active alarm;
filter each affected node for a change request (CR); or
filter each affected node for a planned event; and
classify remaining affected nodes as being without alarms.

11. The system of claim 9, wherein the non-transitory instructions further cause the processing circuitry to:
determine a node type for each of the connected nodes.

12. The system of claim 9, wherein the non-transitory instructions further cause the processing circuitry to:
determine a node name for each of the connected nodes.

13. The system of claim 9, wherein the non-transitory instructions further cause the processing circuitry to:
cause a graphical user interface (GUI) to be output by a display, the GUI comprising:
a first column configured to display each affected node experiencing an active alarm event;
a second column configured to display each affected node experiencing a partial active alarm event;
a third column configured to display each affected node experiencing a CR or planned event; and
a fourth column configured to display each affected node not displayed in the first, second, and third column.

14. The system of claim 9, wherein the non-transitory instructions further cause the processing circuitry to:
cause a GUI to be output by a display, the GUI comprising:
a node name for each affected node, where the node name is grouped and displayed with a heading as to the alarm event affecting each affected node.

15. The system of claim 14, wherein the GUI is a first GUI, the first GUI further comprises:
a hyperlink embedded within each affected node name, wherein:
responsive to a user interface action on a selected node name, the non-transitory instructions further cause the processing circuitry to:
cause a second GUI to be output by the display, the second GUI comprising:
a listing of each alarm event for the selected node name.

16. The system of claim 9, wherein the non-transitory instructions further cause the processing circuitry to:
monitor each affected node for an alarm event.

17. A computer-readable medium including instructions executable by processing circuitry to cause the processing circuitry to perform operations comprising:
determining a first node affected by an alarm event in a network;
obtaining each affected node connected to the first node from a topology application programming interface (API);
obtaining alarm events associated with each of the connected nodes from an alarm API; and
filtering each affected node based on an event classification.

18. The computer-readable medium of claim 17, wherein the instructions further cause the processing circuitry to perform operations comprising:
filtering each affected node for an active alarm;
filtering each affected node for a partially active alarm;
filtering each affected node for a change request (CR); or
filtering each affected node for a planned event; and
classifying remaining affected nodes as being without alarms.

19. The computer-readable medium of claim 17, wherein the instructions further cause the processing circuitry to perform operations comprising:
determining a node type for each of the connected nodes.

20. The computer-readable medium of claim 17, wherein the instructions further cause the processing circuitry to perform operations comprising:
determining a node name for each of the connected nodes.
